(19) United States
(12) Patent Application Publication
(10) Pub. No.: US 2025/0011485 A1
(43) Pub. Date: Jan. 9, 2025

(54) VINYL CHLORIDE COPOLYMER AND COPOLYMER COMPOSITION, AND AN ARTICLE COMPRISING THE SAME

(71) Applicant: SCG CHEMICALS PUBLIC COMPANY LIMITED, Bangkok (TH)

(72) Inventors: Churat TIYAPIBOONCHAIYA, Chonburi (TH); Chantana SAE-LIM, Rayong (TH); Sombat TANNARAT, Rayong (TH)

(21) Appl. No.: 18/708,186

(22) PCT Filed: Nov. 9, 2022
(86) PCT No.: PCT/IB2022/060764

§ 371 Date: May 7, 2024

(30) Foreign Application Priority Data
Nov. 16, 2021 (TH) 2101007108

(51) Int. Cl. C08F 214/06

(52) U.S. Cl. CPC C08F 214/06; C08F 2800/20

(57) ABSTRACT

The present invention relates to a copolymer comprising a vinyl chloride polymer unit in a range of 90-99 wt %, a maleate polymer unit in a range of 0.5-10 wt %, and an acrylate polymer unit in a range of 0-5 wt %. Furthermore, the present invention also relates to a copolymer composition and an article comprising the same.

### TECHNICAL FIELD

Chemistry related to a copolymer and copolymer composition and an article comprising the same

### BACKGROUND OF THE INVENTION

Vinyl chloride polymer, also known as polyvinyl chloride or PVC, is a thermoplastic with the preferred properties such as having good chemical and water resistance, and good electrical insulation. Accordingly, it is commonly used for the production of articles in various industries, e.g., water-pipes, cling films, food wrapping films, stickers, wire covering insulators, and cables, etc. However, PVC has certain disadvantages, that are, low thermal resistance, brittleness, and low elasticity. Thus, it cannot be molded into certain types of articles as required. Therefore, in order to mold PVC into the article that requires some specific properties, PVC needs to be mixed with other ingredients, e.g., additives or other types of polymers to improve the properties such as thermal resistance, low temperature resistance, flexibility, strength, and elasticity of the polymer or polymer composition to be molded to be suitable for the application of final product as required.

Common problems when mixing PVC to other ingredients i.e., incompatibility between PVC and other ingredients, such as plasticizers and additives, etc. This causes migration or transfer of additives out of the article content, or an uneven surface of the article on which the fisheye is found. For example, in case there is a need for improvement of the softness of polymers and for articles with smooth surface, it can be achieved by adding plasticizers and additives. It takes time for plasticizers to be adsorbed into the pores of PVC, and thus it consumes a lot of energy to adsorb plasticizers. As a result, thermal resistance of the molded article is decreased. Furthermore, if a particle size of PVC is larger than 500 μm, the fisheye is likely to be found on the article's surface, and after a long-term usage of the article, plasticizers adsorbed into such pores will migrate out of the article's surface, reducing the softness of the article. Furthermore, in certain applications that require specific properties such as good oil resistance, adding a large amount of plasticizer to achieve the required softness will result in the reduction of oil resistance of the article, which makes the article properties fail to meet the requirements or stipulated standards. On the other hand, if the amount of plasticizer is reduced, it will negatively affect certain physical properties of the article; or in applications that require improvement of melting property of the production such as molding into credit cards by high-temperature laminating, such as over 120° C., which can damage the embedded chip due to high heat during the production. Therefore, in this kind of application, the polymer properties usually be improved by mixing PVC with another polymer such as vinyl chloride-vinyl acetate copolymer to allow laminating at the temperature of 120° C. or lower, complicating the preparation step.

Therefore, there are attempts to invent and develop an approach to solve the aforementioned problems, as well as to improve the properties of PVC resin to make it suitable for applications. Examples of patent document that discloses an approach to improve the properties of resin which is a copolymer of PVC are as follows:

WO 2019/066496 A1 discloses the vinyl chloride-based resin composition, including a copolymer of monomer comprising vinyl chloride monomer in a range of 10-90 parts by weight, ethylenically unsaturated monomer in a range of 0.1-50 parts by weight, (meth)acrylic ester monomer) with the linear, branched, or cyclic alkyl group having 10-20 carbon atoms in a range of 1.0 parts by weight or more, and a hydroxyl monomer in a range of 1-30 parts by weight.

EP 2 067 795 A1 discloses a production process of copolymerized or grafted polyvinyl halide resin. This comprises (A) 90.0 wt %˜99.9 wt % relative to a combined composition of vinyl halide monomer or a mixture of vinyl halide monomer-based polymerizable monomer, and (B) 10.0 wt %˜0.1 wt % relative to a combined composition of alkyl acrylate monomer or latex or alkyl acrylate/acrylate-based polymer powder.

CN 104250334 B discloses a method for preparing vinyl chloride-acrylate copolymer comprising a reaction between vinyl chloride monomer in an amount ranging from 90-99.5 wt %, and acrylate monomer in an amount ranging from 0.5-10 wt %.

However, despite the research and development of various approaches to improve the properties of polyvinyl chloride, particularly, to improve the properties of polymers using copolymerization of vinyl chloride monomer together with other comonomers as disclosed in the above examples of prior art, there remains a need for development or improvement of properties of polyvinyl chloride as well as its copolymers to satisfy the need to use such polymers in various applications.

### SUMMARY OF THE INVENTION

An objective of the present invention is to provide a copolymer of polyvinyl chloride (PVC) of which certain properties are improved to be suitable for various applications as required, particularly elasticity, thermal resistance, low temperature resistance, strength, oil resistance properties, including the ability to be molded at high-low temperature as required.

Another objective of the present invention is to provide a copolymer composition and an article made from or comprising the copolymer according to the present invention with the properties suitable for various applications, including rigid applications, e.g., drinking water pipes, doors, windows, moldings, panel moldings, electrical conduits, corridor floors, cable trays and rigid foam boards; semi rigid applications, e.g., films, sheets, blister packs, stickers, credit cards, semi rigid plastic sheets, shrink sleeves, and cling films; soft applications, e.g., soft plastic sheets, cables, indoor wires, outdoor wires, automotive wires, rubber tiles, refrigerator seals, mirror edge seals, electrical tapes, artificial leathers, and soft plastic sheets; and adhesive applications, e.g., PVC pipe glue.

The first aspect of the present invention relates to a copolymer comprising:
a. a vinyl chloride polymer unit in a range of 90-99 wt %, preferably 93-99 wt %;
b. a maleate polymer unit in a range of 0.5-10 wt %, preferably 0.5-7 wt %; and
c. an acrylate polymer unit in a range of 0-5 wt %, preferably 0.5-5 wt %.

In another embodiment, the copolymer according to the present invention comprises:
a. the vinyl chloride polymer unit in a range of 90-98 wt %; and
b. the maleate polymer unit in a range of 2-10 wt %.

The second aspect of the present invention relates to a copolymer composition comprising the copolymer according to the present invention, where the copolymer composition may also comprise other polymers, additives, or a combination thereof. That is, the copolymer composition may comprise the copolymer according to the present invention and one or more of other polymers; or may comprise the copolymer according to the present invention and additives; or may comprise the copolymer according to the present invention together with one or more of other polymers and additives. The additives can be of any types used to improve the properties of the copolymer composition to be suitable for applications, e.g., stabilizers, impact modifiers, plasticizers, fillers, lubricants, flame retardants, foaming agents, pigments, or a combination thereof.

The third aspect of the present invention relates to an article made from or comprising the copolymer or copolymer composition according to the present invention.

The copolymer according to the present invention, the copolymer composition comprising such copolymer and the article made from or comprising this copolymer or copolymer composition possess good physical properties such as hardness and elasticity, good adhesiveness at low temperature; reduce the use of additives which can solve or reduce problems, e.g., migration of plasticizers out of the article's surface. Furthermore, they offer good appearance of the article, as well as low power consumption for molding and easy molding into the article.

### DETAILED DESCRIPTION

Any aspects shown herein shall encompass the application to other aspects according to the present invention, unless stated otherwise.

Technical terms and scientific terms used herein have meanings as understood by a person of ordinary skill in the art, unless determined otherwise.

Throughout the present invention, the term “about” is used to indicate that any values appearing or shown herein may be varied or deviate. Such variation or deviation may be caused by error of equipment or method used to determine the values.

The terms “consist(s) of,” “comprise(s),” “contain(s),” and “include(s)” are open-end verbs. For example, any method which “consists of,” “comprises,” “contains” or “includes” one component or multiple components or one step or multiple steps is not limited to only one component or one step or multiple steps or multiple components, but also encompasses components or steps that are not specified.

Tools, devices, methods, materials, or chemicals mentioned herein, unless specified otherwise, mean the tools, devices, methods, materials, or chemicals generally used or practiced by a person skilled in the art.

All components and/or methods disclosed and claimed in the present invention are intended to cover the aspects of the invention obtained from an action, a practice, a modification or a change of any factors which does not require any experiment that is substantially different from the present invention and gives properties and utility and provides the same effect as the aspects according to the present invention according to the judgement of a person of ordinary skill in the art, although not specifically stated in the claims. Therefore, substitutions or analogues of the aspects according to the present invention, and any slight modifications or changes that is clearly apparent to a person of ordinary skill in the art, are considered to be within the spirit, the scope, and concept according to the present invention as well.

### Definitions

The term “polymer unit” according to the present invention shall refer to any parts of polymer or copolymer chain constituted of or formed by more than one monomer units or repeating units. The term “polymer unit” as used herein shall include an oligomer of such monomer units or repeating units as well.

The term “vinyl chloride polymer unit” according to the present invention shall refer to any parts of copolymer chain constituted of or formed by more than one vinyl chloride repeating units or vinyl chloride oligomers.

The term “maleate polymer unit” according to the present invention shall refer to any parts of copolymer chain constituted of or formed by more than one maleate repeating units or maleate oligomers.

The term “acrylate polymer unit” according to the present invention shall refer to any parts of copolymer chain constituted of or formed by more than one acrylate repeating units or acrylate oligomers.

Now, the present invention will be described in more detail with reference to the examples of experiments and the property test results, but not intended to limit the scope of the invention.

The first aspect of the present invention relates to a copolymer comprising:
a. a vinyl chloride polymer unit in a range of 90-99 wt %;
b. a maleate polymer unit in a range of 0.5-10 wt %; and
c. an acrylate polymer unit in a range of 0-5 wt %.

According to a preferred embodiment of the present invention, the copolymer comprises:
a. the vinyl chloride polymer unit in a range of 93-99 wt %;
b. the maleate polymer unit in a range of 0.5-7 wt %; and
c. the acrylate polymer unit in a range of 0.5-5 wt %.

In another preferred embodiment of the present invention, the copolymer comprises:
a. the vinyl chloride polymer unit in a range of 90-98 wt %; and
b. the maleate polymer unit in a range of 2-10 wt %.

Maleate according to the invention may be dialkyl maleate, preferably dialkyl maleate having carbon in a range of 6-36 atoms. Exemplary dialkyl maleate may be selected from a group consisting of di-2-ethylhexyl maleate, dimethyl maleate, dicetyl maleate, and a combination thereof.

Acrylate according to the invention may be alkyl acrylate, preferably alkyl acrylate having carbon in a range of 4-21 atoms. Exemplary alkyl acrylate may be selected from a group consisting of 2-ethylhexyl acrylate, methyl acrylate, stearyl acrylate, and a combination thereof.

According to the present invention, the copolymer has K-value in a range of 50-84. Preferably, in case the copolymer comprises vinyl chloride polymer unit, maleate polymer unit and acrylate polymer unit, in the above-specified range, the copolymer has K-value in a range of 50-75. And in case the copolymer comprises vinyl chloride polymer unit and maleate polymer unit, that is, no acrylate polymer unit, the copolymer has K-value in a range of 61-84.

The copolymer with the above-specified K-values is selected to be suitable for applications or properties of the final product. For example, for rigid applications, the preferred copolymer will have a low-medium K-value; or for semi rigid or soft applications, the preferred copolymer will have a medium-high K-value, etc.

The copolymer according to the present invention is suitable for various applications, for examples,
rigid applications that can be selected from a group consisting of drinking water pipes, doors, windows, moldings, panel moldings, electrical conduits, corridor floors, cable trays, and rigid foam boards, etc.;
semi rigid applications that can be selected from a group consisting of films, sheets, blister packs, stickers, credit cards, semi rigid plastic sheets, shrink sleeves, and cling films, etc.;
soft applications that can be selected from a group consisting of soft plastic sheets, cables, indoor wires, outdoor wires, automotive wires, rubber tiles, refrigerator seals, mirror edge seals, electrical tapes, artificial leathers, and soft plastic sheets, etc.;
adhesive applications such as PVC pipe glue.

The second aspect of the present invention relates to a copolymer composition comprising the copolymer according to the present invention with the aspects and properties as specified above.

The copolymer composition according to the present invention may also comprises other polymers, additives, or a combination thereof. That is, the copolymer composition may comprise the copolymer according to the present invention and one or more of other polymers; or may comprise the copolymer according to the present invention and additives; or may comprise the copolymer according to the present invention together with one or more of other polymers and additives.

Any additives that can improve the properties of the copolymer composition to be suitable for applications may be used. For example, it may be selected from a group consisting of stabilizers, impact modifiers, plasticizers, fillers, lubricants, flame retardants, foaming agents, pigments, and a combination thereof.

Examples of stabilizers usable according to the present invention are agents that can be selected from a group consisting of non-Pb stabilizers such as tin stabilizers, methyl tin stabilizers, octyl tin stabilizers, organotin stabilizers, calcium zinc stabilizers; Pb stabilizers such as tribasic lead sulphate (TBLS), dibasic lead phosphite, dibasic lead stearate (DBL), etc.

Examples of impact modifiers usable according to the present invention are agents that can be selected from a group consisting of methyl butadiene styrene (MBS), acrylic impact modifier (AIM), chlorinated polyethylene modifier (CPE).

Examples of plasticizers usable according to the present invention can be selected from a group consisting of phthalates such as diisodecyl phthalate (DIDP), diisononyl phthalate (DINP), benzyl butyl phthalate (BBP) etc.; non-phthalates such as dioctyl adipate (DOA), trioctyl trimellitate (TOTM), adipic acid polyester, dioctyl phthalate (DOP), epoxidized soybean oil (EPO), etc.

Examples of fillers usable according to the present invention are agents that can be selected from a group consisting of calcium carbonate (CaCO3), kaolin, etc.

Examples of lubricants usable according to the invention are wax, preferably polyethylene wax, etc.

The third aspect of the present invention relates to an article comprising the copolymer or copolymer composition according to the present invention.

An article according to the present invention is suitable for various applications for examples,
rigid applications that can be selected from a group consisting of drinking water pipes, doors, windows, moldings, panel moldings, electrical conduits, corridor floors, cable trays, and rigid foam boards, etc.;
semi rigid applications that can be selected from a group consisting of films, sheets, blister packs, stickers, credit cards, semi rigid plastic sheets, shrink sleeves, and cling films, etc.;
soft applications that can be selected from a group consisting of soft plastic sheets, cables, indoor wires, outdoor wires, automotive wires, rubber tiles, refrigerator seals, mirror edge seals, electrical tapes, artificial leathers, soft plastic sheets, etc.; or
adhesive applications such as PVC pipe glue.

A method of preparing the copolymer according to the present invention can be performed using any suitable method known in the art.

### EXPERIMENTAL EXAMPLES

To study properties of the copolymer according to the present invention as well as the copolymer composition and the article made from or comprising the copolymer according to the present invention, the polymer examples e.g., Examples 1-8 which are the copolymers according to the present invention, Comparative Examples 1 and 2 which are the polyvinyl chloride homopolymers and Comparative Examples 3 and 4 which are the copolymers, were prepared, provided that each example has different amount and different type of respective polymer unit, as shown in Table 1.

TABLE 1

| | Amount of Polymer Unit (wt %) | | |
|---|---|---|---|
| | Vinyl | Di-2-ethylhexyl | 2-ethylhexyl |
| Polymer Example* | chloride | maleate | acrylate |
| Comparative Example 1 | 100 | 0 | 0 |
| Comparative Example 2 | 100 | 0 | 0 |
| Comparative Example 3 | 99.6 | 0.4 | 0 |
| Comparative Example 4 | 89 | 11 | 0 |
| 1 | 98 | 2 | 0 |
| 2 | 98 | 1 | 1 |
| 3 | 97 | 1 | 2 |
| 4 | 97 | 0.5 | 2.5 |
| 5 | 94.5 | 2 | 3.5 |
| 6 | 93 | 7 | 0 |
| 7 | 95 | 5 | 0 |
| 8 | 91 | 9 | 0 |

*K-values of Comparative Example 1 and Examples 1-5 were 61, K-values of Comparative Examples 2-4 and Examples 6-8 were 71.

The polymer examples were tested for properties, i.e., the mean particle size of polymers, plasticizer absorption time (PAT), and glass transition temperature (Tg) as detailed below.

### 1) Determination of Mean Particle Size

To determine the mean particle size of polymers, the dry polymer powder was put through the sieves with different opening sizes stacked with larger openings at the top and smaller openings at the bottom, respectively. The sieves were shaken using a sieve shaker for 10 minutes. Then, calculate a particle size of the dry polymer powder using the following formula:

$$Polymer powder size = [ ( P 1 \times D 1 ) + ( P 2 \times D 2 ) + \text{.....} + ( Pn \times Dn ) ] \times 100$$

where P1, P2, . . . , Pn are the amount in percent (%) of polymer powder remaining on the sieves with different opening sizes;

D1, D2, . . . , Dn are the mean opening size of the sieves in, such as, μm (micron).

For example, P1 is a percentage of dry polymer powder remaining on the sieves with the mean opening size of D1.

### 2) Determination of Plasticizer Absorption Time (PAT)

The plasticizer absorption time can be determined by the method according to ASTM D2396-88 standard. The plasticizer absorption time is a period of time from addition of plasticizer into the composition until a kneading torque of a planetary mixer reaches the minimum.

### 3) Determination of Glass Transition Temperature (Tg)

The glass transition temperature can be determined by differential scanning colorimeter (DSC) to analyse the heat change of polymers by placing the test sample (polymer) in one tray and using another tray as a reference tray, then, heat them. The DSC will read the temperature that causes the polymer chemical change.

The above test results, i.e., the mean particle size, plasticizer absorption time (PAT), and glass transition temperature (Tg) of the polymer examples shown in Table 2.

TABLE 2

| | Mean Particle Size | PAT | Tg |
|---|---|---|---|
| Example | (μm) | (second) | (° C.) |
| Comparative Example 1 | 116 | 269 | 81 |
| Comparative Example 2 | 135 | 242 | 84.2 |
| Comparative Example 3 | 138 | 193 | 84 |
| Comparative Example 4 | 234 | 135 | 57 |
| 1 | 118 | 198 | 77 |
| 2 | 113 | 210 | 79 |
| 3 | 113 | 206 | 75 |
| 4 | 116 | 208 | 75 |
| 5 | 125 | 202 | 73 |
| 6 | 138 | 145 | 73.1 |
| 7 | 138 | 176 | 77.9 |
| 8 | 135 | 135 | 68.9 |

From the above test results, it was found that the plasticizer absorption time (PAT) of the copolymer examples according to the present invention (Examples 1-8) was significantly lower than that of the comparative examples which were polyvinyl chloride homopolymers (Comparative Examples 1 and 2). The lower PAT had the positive effects of lower time and energy used in mixing agents, allowing the production cost to be reduced. Furthermore, it also helped delay the degradation of polymers.

Furthermore, when compared only the copolymer comprising vinyl chloride polymer unit to di-2-ethylhexyl maleate polymer unit, that is, examples according to the present invention Examples 1, 6, 7 and 8 and Comparative Examples 3 and 4, it was found that the copolymer containing the amount of di-2-ethylhexyl maleate polymer unit in a range from 0.5-10 wt % according to the present invention (Examples 1, 6, 7 and 8) had significantly lower glass transition temperature (Tg) compared to the copolymer with the amount of di-2-ethylhexyl maleate polymer unit lower than 0.5 wt % (Comparative Example 3); and even the copolymer with the amount of di-2-ethylhexyl maleate polymer units over 10 wt % (Comparative Example 4) had the lower glass transition temperature compared to the copolymer according to the present invention (Examples 1, 6, 7 and 8). However, when comparing the particle size of the copolymers, it was found that the copolymer according to Comparative Example 4 had a much larger particle size compared to the copolymer examples according to Examples 1, 6, 7 and 8. Furthermore, it was also found that the copolymer according to Comparative Example 4 had the amount of the particles that were larger than 500 μm of up to 10%, resulting in a high possibility of finding the fisheye when making the article.

### Test Results

Then, the copolymer examples were taken to prepare the copolymer composition and article according to the applications, i.e., molding into credit cards, cable sheath, and cling films, as detailed below.

### 1. Credit Card

The copolymer examples and the comparative polymer examples were taken to prepare the composition examples with different amount and different types of additives. Then, the composition examples and articles molded from the said composition examples were tested for properties, i.e., impact strength, lamination, and heat stability as detailed below.

### 1) Izod Impact Strength

The Izod impact strength was determined according to ASTM D-256 (2018) standard. The tested composition examples are 3 mm thick, marked by a V-shaped notch, and hit with the 5.5J pendulum.

### 2) Lamination Property Test

The laminate molding test of the composition examples was performed by preparing the laminate sample from each composition example with a thickness of 0.5 mm at a temperature of 140° C. The resulting laminates were molded into a work piece by splicing 2 sample laminates together in a 1 mm thick frame under the pressure of 50 bars at a temperature of 100, 110 and 120° C. for 5 minutes using the hot press. After completion, the attachment of work piece laminate was examined and evaluated by rating from 0 to 5, where 0=not attached, and 5=well-attached.

### 3) Heat Stability Test

The heat stability of the composition examples was determined using the metrastat machine at a temperature of 200° C. for 100 minutes and using the 0.5 mm thick composition examples. The heat stability was examined by visual observation for discoloration and other signs indicating degradation. Also, the time of initial discoloration of the test samples and the time of burnt discoloration of the composition examples were recorded.

The composition examples 1-5 prepared from the copolymer examples 1-5 (in Table 1), respectively, and the comparative composition example 1 prepared from the comparative polymer example 1 (in Table 1), where the composition examples have different amount and different types of additives, and the afore-mentioned property test results are shown in Table 3.

TABLE 3

| | Composition Example | | | | | |
|---|---|---|---|---|---|---|
| Component in the Composition | Comparative | | | | | |
| (kg) | Example 1 | 1 | 2 | 3 | 4 | 5 |
| Polymer * | 100 | 100 | 100 | 100 | 100 | 100 |
| Methyl tin | 2 | 2 | 2 | 2 | 2 | 2 |
| stabilizer | | | | | | |
| Polyethylene wax | 2.5 | 2.5 | 2.5 | 2.5 | 2.5 | 2.5 |
| Chlorinated | 3 | 3 | 3 | 3 | 3 | 6 |
| polyethylene | | | | | | |

Property

| | | | | | | |
|---|---|---|---|---|---|---|
| Izod impact strength | N/A** | N/A** | N/A** | 4.3 | 5 | 4 |

Lamination evaluation score at different temperatures

| | | | | | | |
|---|---|---|---|---|---|---|
| 100° C. | 0 | 0 | 0 | 0 | 0 | 0 |
| 110° C. | 0 | 0 | 0 | 0 | 0 | 5 |
| 120° C. | 0 | 2 | 3 | 5 | 5 | 5 |

Heat stability

| | | | | | | |
|---|---|---|---|---|---|---|
| Time of initial discoloration | N/A** | N/A** | N/A** | 65 | 65 | 65 |
| (min) | | | | | | |
| Time of burnt discoloration | N/A** | N/A** | N/A** | 90 | 90 | 90 |
| (min) | | | | | | |

Note:
* K-values of polymers in the comparative composition example 1 and the composition examples 1-5 were 61.
**N/A is not laminated, thus cannot be tested; and the lamination evaluation score is scaled from 0 to 5 points, where 0 = not attached, 5 = well-attached.

From the test results in Table 3, it shows that the composition examples comprising the copolymers according to the present invention (Examples 3, 4 and 5) have a significantly increased impact strength compared to Comparative Example 1 comprising vinyl chloride homopolymers.

Upon reviewing the lamination test result at different temperatures, it was found that the composition examples 1-5 according to the present invention can be laminated at a temperature of 120° C., where the composition examples 3-5 exhibits the highest lamination evaluation score (5 points), which shows that the copolymer compositions according to the present invention have the properties suitable for lamination; and at a temperature of 110° C., it was found that only the composition example 5 can be laminated.

The laminating ability at lower temperatures or the higher evaluation score of the compositions according to the present invention result from the lower glass transition temperature (Tg) of polymers compared to the comparative examples (see Table 2). This allows melting at low temperatures. This laminating ability at low temperatures is an extremely necessary property for some applications, particularly, for the manufacture of credit cards or other articles containing devices vulnerable to heat such as chips, etc.

### 2. Cable Sheath

The copolymer examples 6 and 7 (in Table 1) and the comparative polymer example 2 (in Table 1) were used to prepare the composition examples with different amount and different types of additives. Then, the composition examples and articles molded therefrom as well as the comparative composition example 2 were tested for properties, i.e., the fusion time, melt flow index (MFI), volume resistivity (VR), hardness, and migration. The details are as follows.

### 1) Fusion Time

The fusion time was tested according to ASTM D2396:2020 standard by testing the composition examples using a batch mixer at a temperature of 180° C. at a screw speed of 40 rpm, mixing until a torque reduced to a constant value, and record the time to reach the constant torque.

### 2) Melt Flow Index (MFI)

The melt flow index was tested according to ASTM D1238:2020 standard by melting the composition example in a cylinder at a temperature and force weight as determined, weighing the composition example flow out of the cylinder, and calculating the melt flow index using the following formula:

$$MFI = 10 W / T$$

where W is an average weight of extrudated composition example in gram;

T is an extrusion time of the extrudated composition example in minute.

### 3) Volume Resistivity (VR)

The volume resistivity was determined according to ASTM D257 by placing the 2 mm thick composition example between two electrodes and applying voltage for 60 seconds. Then, the surface or volume resistivity was measured. The apparent value (at the time of electric current occurrence of 60 seconds) was calculated and reported.

### 4) Hardness

The hardness was determined according to D2240-68:2021 standard by preparing the work piece of 6 mm thick composition example and testing it with a durometer using Shore A indenter. The test was done at 5 points to determine the average value.

### 5) Migration

The migration of plasticizer was determined by heating the prepared 1 mm thick composition example in an oven at a temperature of 70° C. for 10 days. Then, the percent migration of plasticizer to the surface of such example was calculated using the following formula:

$$Percent Migration = \frac{( Pre - incubation Weight - Post - incubation Weight )}{Pre - incubation Weight} \times 100$$

The composition examples 6 and 7 prepared from the copolymer examples 6 and 7 (in Table 1), respectively, and the comparative composition example 2 prepared from comparative polymer example 2 (in Table 1) with different amount and different types of additives, and the afore-mentioned property test results are shown in Table 4.

TABLE 4

| | Composition Example | | |
|---|---|---|---|
| Composition | Comparative | | |
| Components (kg) | Example 2 | 6 | 7 |
| Polymer * | 100 | 100 | 100 |
| Dioctyl phthalate | 43 | 30 | 35 |
| Tribasic lead sulphate | 5 | 5 | 5 |
| Epoxidized soybean oil | 5 | 5 | 5 |
| Polyethylene wax | 0.3 | 0.3 | 0.3 |
| Calcium carbonate | 30 | 30 | 30 |

Property

| | | | |
|---|---|---|---|
| Plasticizer absorption | 317 | 60 | 85 |
| time (second) | | | |
| Fusion time (min) | 2.09 | 1.2 | 1.23 |
| Melt flow index at 5 kg/ | 15.431 | 18.205 | 17.283 |
| 200° C. (g/10 min) | | | |
| Fisheye | Found | Not found | Not found |
| Volume resistivity | 3.8 | 151.83 | 13.19 |
| ((VR) × 10\hat{ }13 (Ω · cm) | | | |
| Hardness | 90 | 90 | 90 |
| Migration of plasticizer | 0.49 | 0.23 | 0.26 |
| to the surface (%) | | | |

Note:
* K-values of polymers in the comparative composition example 2 and the composition examples 6 and 7 were 71.

The test result in Table 4 shows that the copolymer compositions according to the present invention (the composition examples 6 and 7) exhibit the lower fusion time and the higher melt flow index of polymer compared to the comparative composition example 2. Such better result enables the copolymer compositions according to the present invention to reduce the electric power consumption in the wire production by up to 4.16%. In addition to saving power in the production, it also ensures that no fisheye is found on the outer surface of the exemplary molded work piece of copolymer compositions according to the present invention compared to the comparative composition example 2. This is an advantage of the present invention since the outer surface of the work piece is one of the essential properties to contemplate for practical use.

To use polymers for the manufacture of insulation products such as in cable sheath products, etc., a certain hardness value according to the Industrial Standard (IS) shall be met, and the resistivity needs to be determined. A good insulation material naturally has a high-volume resistivity and low conductivity. From the test results, it was found that the copolymer composition according to the present invention offered a higher resistance to electric current in materials compared to the comparative composition example 2, as a result of the addition of plasticizer additive. In the smaller amount (see Table 4), it caused less electron flow in the materials whereas the hardness value was equal to the comparative composition example 2, that is, the hardness value of articles molded from the copolymer composition according to the present invention did not increase despite the lower amount of oil was added.

As for semi rigid or soft applications, in order to soften the materials, the plasticizer additive needs to be added into the formulation. Adding too much plasticizer may result in the migration of plasticizer to the surface, reducing the softness, degrading certain properties, as well as causing the stickiness on the surface of the work piece, which is undesirable for application, and increasing fragility. From the test above, it was found that the copolymer composition according to the present invention had the lower migration of plasticizer (dioctyl phthalate) compared to the comparative composition example 2 where the hardness value of the work pieces was the same.

Furthermore, it was also found that the copolymer composition example according to the present invention took less plasticizer absorption time than the comparative composition example 2. The said value indicates the time that the polymer takes to adsorb oil. Less plasticizer absorption time means less energy and less mixing time. This can save energy, reduce the processing time, reduce the degradation of polymers or articles molded therefrom, as well as result in the smoother article surface or less fisheye.

### 3. Cling Films

The copolymer example 8 (in Table 1) was taken to prepare the composition example 8 which was the copolymer composition example according to the present invention, and the comparative polymer example 2 (in Table 1) was taken to prepare the comparative composition example 3, using different amount and different types of additives. Then, the composition examples and articles molded therefrom as well as the comparative composition example 3 were tested for properties, i.e., the plasticizer absorption time, hardness, melt flow index, overall migration (OM), and the migration of plasticizer to the surface. The details of determination of plasticizer absorption time, hardness value, melt flow index (MFI) and migration of plasticizer to the surface are as previously described.

The overall migration (OM) test was performed by testing the prepared composition examples according to BS EN 1186-15:2002 standard. This was done by preparing the 14×14 cm test work pieces, weighing the work pieces derived from the respective composition examples, and then immersing them in the iso-octane solution at a temperature of 20° C. for 2 days. After completion, the iso-octane solution was removed before weighing the work pieces immersed therein. Then, the iso-octane was evaporated before weighing the residual additive in the work piece after evaporation. All the measured weights were recorded and calculated to determine the overall migration using the following formula:

$$M = ( A - B ) / S$$

where M is the overall migration in mg/dm².

A is the total weight of the work piece example after evaporation and the container used in evaporation in mg.

B is the weight of the container used in evaporation that is measured before the test in mg.

S is the contact surface area between the work piece example and the solution in dm.

The composition examples contain different amount and different types of additives, and the afore-mentioned property test results are shown in Table 5.

TABLE 5

Composition Example

| Composition | Comparative | |
|---|---|---|
| Component (kg) | Example 3 | 8 |
| Polymer * | 100 | 100 |
| Dioctyl adipate | 30 | 20 |
| Tin stabilizer | 2 | 2 |
| Epoxidized soybean oil | 5 | 5 |
| Polyethylene wax | 2 | 2 |

Property

| | | |
|---|---|---|
| Plasticizer absorption time (second) | 154 | 18 |
| Hardness | 89 | 89 |
| Melt flow index at | 2.56 | 3.48 |
| 10 kg/180° C. (g/10 min) | | |
| Overall migration (OM) (mg/dm²) | 88 | 45 |
| Migration of plasticizer | 25 | 16 |
| to the surface (%) | | |

Note:
* K-values of polymers in the comparative composition example 3 and the composition examples 8 were 71.

The test result in Table 5 shows that plasticizer absorption time of the test work piece of the copolymer example composition according to the present invention is significantly reduced compared to that of the comparative composition example. Less plasticizer absorption time means less energy and less mixing time. This can save energy, as well as reduce the degradation of polymers or articles.

The melt flow index of the test work piece of the copolymer example composition according to the present invention is higher than the comparative composition example.

Taking into account the overall migration (OM) which tests the tolerance against extraction with solutions such as alcohol, it was found that the test work piece of the copolymer example composition of the present invention has the significantly lower overall migration than that of the comparative composition example. This shows that the copolymer example composition of the present invention can better tolerate the extraction with solutions than the comparative composition example.

In general, the semi rigid article requires the addition of plasticizer to ensure that the article has the suitable hardness for application, and the migration of plasticizer to surface of the article will occur over time, causing the stickiness on surface of the article, which is undesirable for application, and increasing fragility. From Table 5, it was found that the migration of plasticizer to the surface of the test work piece made from the copolymer composition example according to the present invention was significantly lower than that of the test work piece made from the comparative composition example.

From all of the above test results, it can be concluded that the copolymer of polyvinyl chloride as well as the copolymer composition comprising such copolymer according to the present invention has the improved properties. That is, it can be molded at lower temperatures, and melted more easily, which is allowed to save the energy in making the work piece. It can also tolerate solutions well. In other words, the migration of plasticizer to the surface is reduced. Furthermore, it was also found that the copolymer of polyvinyl chloride according to the present invention can solve the fisheye problem on the surface of the work piece or article, so that the article has the more pleasing and attractive appearance, and the longer useful life.

### Best Mode of the Invention

Best mode of the invention is as described in the detailed description of the invention.

1. A copolymer comprising:
a. a vinyl chloride polymer unit in a range of 90-99 wt %;
b. a maleate polymer unit in a range of 0.5-10 wt %; and
c. an acrylate polymer unit in a range of 0-5 wt %.

2. The copolymer according to claim 1, wherein:
a. the vinyl chloride polymer unit in a range of 93-99 wt %;
b. the maleate polymer unit in a range of 0.5-7 wt %; and
c. the acrylate polymer unit in a range of 0.5-5 wt %.

3. The copolymer according to claim 1, wherein:
a. the vinyl chloride polymer unit in a range of 90-98 wt %; and
b. the maleate polymer unit in a range of 2-10 wt %.

4. The copolymer according to claim 1, wherein the maleate polymer is dialkyl maleate.

5. The copolymer according to claim 4, wherein the dialkyl maleate has carbon in a range of 6-36 atoms.

6. The copolymer according to claim 4, wherein dialkyl maleate is selected from a group consisting of di-2-ethylhexyl maleate, dimethyl maleate, dicetyl maleate, and a combination thereof.

7. The copolymer according to claim 1, wherein the acrylate polymer is alkyl acrylate.

8. The copolymer according to claim 7, wherein the alkyl acrylate has carbon in a range of 4-21 atoms.

9. The copolymer according to claim 7, wherein the alkyl acrylate is selected from a group consisting of 2-ethylhexyl acrylate, methyl acrylate, stearyl acrylate, and a combination thereof.

10. The copolymer according to claim 1 having a K-value in a range of 50-84.

11. The copolymer according to claim 2 having a K-value in a range of 50-75.

12. The copolymer according to claim 3 having a K-value in a range of 61-84.

13. The copolymer according to claim 1, for rigid applications, preferably drinking water pipes, doors, windows, moldings, panel moldings, conduits, corridor floors, cable trays, and rigid foam boards; semi rigid applications, preferably films, sheets, blister packs, stickers, credit cards, semi rigid plastic sheets, shrink sleeves, and cling films; soft applications, preferably soft plastic sheets, cables, indoor wires, outdoor wires, automotive wires, rubber tiles, refrigerator seals, mirror edge seals, electrical tapes, artificial leathers, and soft plastic sheets; or adhesive applications, preferably PVC pipe glue.

14. A copolymer composition comprising the copolymer according to claim 1.

15. The copolymer composition according to claim 14 further comprising other polymers, additives, or a combination thereof.

16. The copolymer composition according to claim 15, wherein the additives is are selected from a group consisting of stabilizers, impact modifiers, plasticizers, fillers, lubricants, flame retardants, foaming agents, pigments, and a combination thereof.

17. An article of manufacture comprising the copolymer according to claim 1.

18. The article of manufacture according to claim 17 for rigid applications, preferably drinking water pipes, doors, windows, moldings, panel moldings, conduits, corridor floors, cable trays, and rigid foam boards; semi rigid applications, preferably films, sheets, blister packs, stickers, credit cards, semi rigid plastic sheets, shrink sleeves, and cling films; soft applications, preferably soft plastic sheets, cables, indoor wires, outdoor wires, automotive wires, rubber tiles, refrigerator seals, mirror edge seals, electrical tapes, artificial leathers, and soft plastic sheets; or adhesive applications, preferably PVC pipe glue.
